(19) United States
(12) Patent Application Publication
(10) Pub. No.: US 2015/0372900 A1
(43) Pub. Date: Dec. 24, 2015

(54) COMMUNICATION SYSTEM, CONTROL APPARATUS, COMMUNICATION CONTROL METHOD, AND PROGRAM

(71) Applicant: NEC Corporation, Tokyo (JP)

(72) Inventors: Yuta ASHIDA, Tokyo (JP); Toshio KOIDE, Tokyo (JP)

(21) Appl. No.: 14/766,104

(22) PCT Filed: Feb. 6, 2014
(86) PCT No.: PCT/JP2014/052782

§ 371 Date: Aug. 5, 2015

(30) Foreign Application Priority Data
Feb. 7, 2013 (JP) 2013-022118

(51) Int. Cl. H04L 12/707; H04L 12/813; H04L 12/931; H04L 12/24

(52) U.S. Cl. CPC H04L 45/24; H04L 41/0893; H04L 47/20; H04L 49/35

(57) ABSTRACT

A communication system comprises: a node that requests a processing rule for processing a packet; a control apparatus that notifies a processing rule to the node in response to the request; and a plurality of path calculation apparatuses that calculate a forwarding path of the packet received by the node. The plurality of path calculation apparatuses calculate the forwarding path based on at least one policy for calculating the forwarding path, and notifies the calculated forwarding path to the control apparatus. The control apparatus generates based on one of a plurality of the notified forwarding paths the processing rule for forwarding the packet received by the node.

### CROSS-REFERENCE TO RELATED APPLICATIONS

The present invention is based upon and claims the benefit of the priority of Japanese Patent Application No. 2013-022118 (filed on Feb. 7, 2013), the disclosure of which is incorporated herein in its entirety by reference.

### TECHNICAL FIELD

The present invention relates to a communication system, a control apparatus, a communication control method, and a program. More specifically, the invention relates to a communication system in a network on which centralized control is performed by a control apparatus, the control apparatus, a communication control method, and a program.

### BACKGROUND

In recent years, the technology called OpenFlow (OpenFlow), which is a network architecture of a centralized control type, is proposed (refer to Patent Literature 1 and Non Patent Literatures 1 and 2). OpenFlow identifies communications as end-to-end flows, and performs path control, failure recovery, load balancing, and optimization on a per-flow basis. An OpenFlow switch specified in Non Patent Literature 2 includes a secure channel for communication with an OpenFlow controller. The OpenFlow switch operates according to a flow table in which appropriate adding or rewriting is instructed by the OpenFlow controller. In the flow table, a set of match fields (Match Fields) in which conditions to be matched against a packet header are defined, actions (Actions) defining processing contents, and statistical information (Counters) is defined for each flow (refer to FIG. 17). The processing content for a received packet such as forwarding the received packet from a specified port is defined in an action, for example.

When the OpenFlow switch receives a packet, for example, the OpenFlow switch searches the flow table for an entry having a match field that matches header information of the received packet. When the entry that matches the received packet is found as a result of the search, the OpenFlow switch updates the statistical information (one or more Counters), and executes processing content (e.g., transmission of the packet from a specified port, flooding of the packet, discarding of the packet, or the like) described in the action of the entry. On the other hand, when the entry that matches the received packet is not found as a result of the search, the OpenFlow switch transmits to the OpenFlow controller a request for setting the entry of a flow, or a request for determining the processing content of the received packet, through the secure channel (Packet-In). The OpenFlow switch receives the flow entry associated with the request, and then updates the flow table (FlowMod). In this way, the OpenFlow switch performs packet forwarding by using the entry stored in the flow table as a processing rule.

Patent Literature 1 discloses that an OpenFlow controller calculates a packet path, based on a multi-hop Djikstra algorithm (multi-hop Djikstra algorithm), and generates a processing rule for implementing the calculated path.

Patent Literature 2 discloses a path information management system including a plurality of route servers each configured to collect path information and manage routing and routers each configured to execute packet routing, as an example of a different architecture of the centralized control type.

In Patent Literature 2, when receiving an inquiry about a forwarding path from one of the routers, the route server generates optimum path information and second-best route information (path determination information) starting from the router that has made the inquiry, based on a predetermined path determination procedure set in advance. The router receives the path information transmitted by the route server, and forwards a packet, based on the received path information.

### CITATION LIST

### Patent Literature

PTL 1:
International Publication No. WO2008/095010
PTL 2:
JP Patent Kokai Publication No. JP2010-199800A

### Non Patent Literature

NPL 1:
Nick McKeown and seven other authors, “OpenFlow: Enabling Innovation in Campus Networks,” [online], [Searched on October 31, Heisei 23], Internet <URL: http://www.openflowswitch.org/documents/openflow-wp-latest.pdf>.
NPL 2:
“OpenFlow Switch Specification, Version 1.1.0 Implemented (Wire Protocol 0x02),” [online] [Searched on January 11, Heisei 25], Internet <URL: http://www.openflowswitch.org/documents/openflow-spec-v1.1.0.pdf>.

### SUMMARY

### Technical Problem

Each disclosure of the above-listed Patent Literatures and Non Patent Literatures is incorporated herein by reference. The following analysis is given by the present invention. When a control apparatus can select a route for forwarding a packet from among a plurality of forwarding paths in an architecture of the centralized control type, flexibility of flow control can be improved. However, according to Patent Literatures 1 and 2, the control apparatus (OpenFlow controller or route server) performs forwarding path calculation. Thus, in order to expand the range of choices for a packet forwarding path, the number of forwarding paths to be calculated by the control apparatus must be increased. Thus, there arises a problem that a processing load on the control apparatus configured to perform forwarding path calculation increases.

Then, avoidance of an increase in processing load of an apparatus configured to calculate a forwarding path while improving flexibility of flow control has become a challenge. An object of the invention is to provide a communication system, a control apparatus, a communication control method, and a program that contribute to solving the above-mentioned problem.

### Solution to Problem

According to a first aspect of the present invention, there is provided a communication system, comprising: a node that requests a processing rule for processing a packet; a control apparatus that notifies a processing rule to the node in response to the request; and a plurality of path calculation apparatuses that calculate a forwarding path of the packet received by the node. The plurality of path calculation apparatuses calculate the forwarding path based on at least one policy for calculating the forwarding path, and notifies the calculated forwarding path to the control apparatus. The control apparatus generates based on one of a plurality of the notified forwarding paths the processing rule for forwarding the packet received by the node.

According to a second aspect of the present invention, there is provided a control apparatus, comprising: first means that generates a processing rule for processing a packet received by a node, in response to a request from the node; and second means that receives a plurality of forwarding paths of the packet from a plurality of path calculation apparatuses that calculate at least one of the forwarding paths of the packet received by the node based on at least one policy for calculating the at least one forwarding path. The first means generates based on one of the plurality of forwarding paths received by the second means the processing rule for forwarding the packet received by the node.

According to a third aspect of the present invention, there is provided a communication control method, comprising: by a control apparatus, generating a processing rule for processing a packet received by a node, in response to a request from the node; and receiving a plurality of forwarding paths of the packet from a plurality of path calculation apparatuses that calculate at least one of the plurality of forwarding paths of the packet received by the node based on at least one policy for calculating the at least one forwarding path. The control apparatus generates based on one of the plurality of received forwarding paths the processing rule for forwarding the packet received by the node.

According to a fourth aspect of the present invention, there is provided a program, causing a control apparatus configured to control a node that processes a packet to execute: generating a processing rule for processing the packet received by the node; receiving a plurality of forwarding paths of the packet from a plurality of path calculation apparatuses that calculate at least one of the plurality of forwarding paths of the packet received by the node based on at least one policy for calculating the at least one forwarding path; and generating based on one of the plurality of received forwarding paths the processing rule for forwarding the packet received by the node. The program can be provided as a program product recorded on a non-transitory computer-readable storage medium (non-transitory computer-readable storage medium).

### Advantageous Effects of Invention

According to the communication system, the control apparatus, the communication control method, and the program of the present invention, an increase in processing load of each apparatus configured to perform path calculation can be avoided while improving flexibility of flow control

### BRIEF DESCRIPTION OF THE DRAWINGS

FIG. 1 is a diagram illustrating a configuration example of a system in an exemplary embodiment of the present invention.

FIG. 2 is a diagram illustrating an example of a configuration of a system in a first exemplary embodiment.

FIG. 3 is a diagram illustrating an example of a configuration of a control apparatus in the first exemplary embodiment.

FIG. 4 is a diagram illustrating a configuration example of a path calculation apparatus in the first exemplary embodiment.

FIG. 5 is a diagram illustrating an example of a forwarding path in the first exemplary embodiment.

FIG. 6 is a diagram illustrating a configuration example of a packet communication apparatus in the first exemplary embodiment.

FIG. 7 is a flowchart illustrating an operation example of the path calculation apparatus in the first exemplary embodiment.

FIG. 8 is a flowchart illustrating an operation example of the control apparatus in the first exemplary embodiment.

FIG. 9 is a sequence diagram illustrating an operation example of the system in the first exemplary embodiment.

FIG. 10 is a flowchart illustrating a different operation example of the path calculation apparatus in the first exemplary embodiment.

FIG. 11 is a flowchart illustrating a different operation example of the control apparatus in the first exemplary embodiment.

FIG. 12 is a sequence diagram illustrating a different operation example of the system in the first exemplary embodiment.

FIG. 13 is a diagram illustrating a configuration example of a path calculation apparatus in a second exemplary embodiment.

FIG. 14 is a diagram illustrating an example of a configuration of a control apparatus in a third exemplary embodiment.

FIG. 15 is a flowchart illustrating an operation example of the control apparatus in the third exemplary embodiment.

FIG. 16 is a flowchart illustrating a different operation example of the control apparatus in the third exemplary embodiment.

FIG. 17 is a diagram illustrating a configuration example of a processing rule.

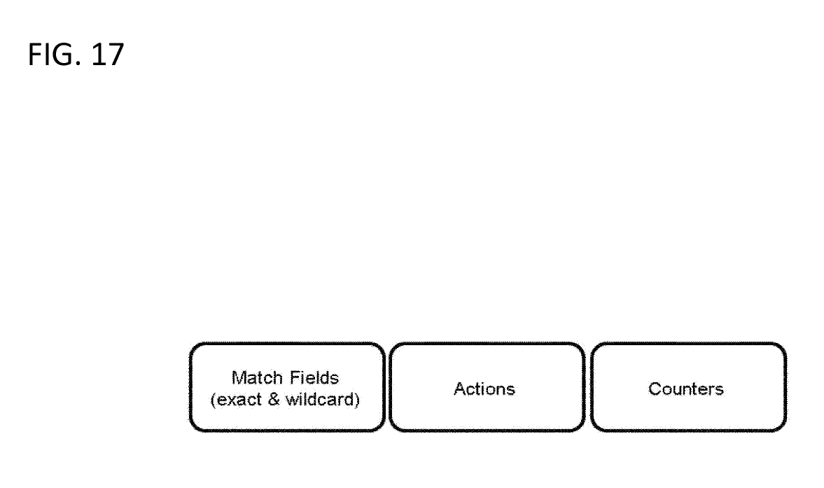

### DESCRIPTION OF EMBODIMENTS

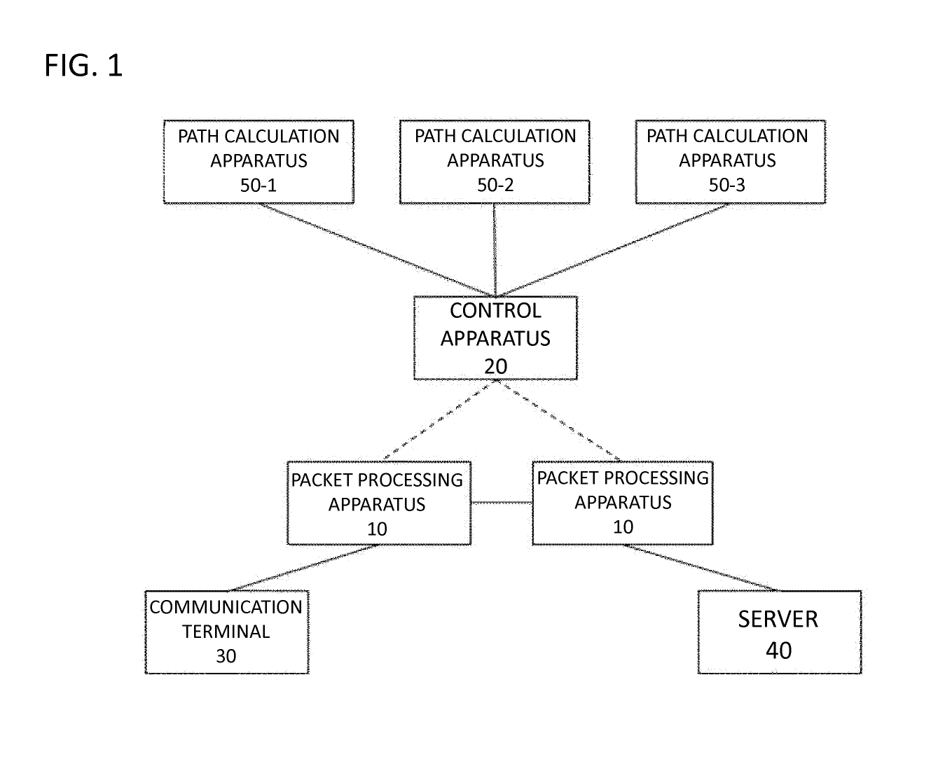

First, an overview of an exemplary embodiment of the present invention will be described with reference to the drawings. As illustrated in FIG. 1, the present invention can be implemented by a configuration including packet processing apparatuses 10 configured to implement communication between a communication terminal 30 and a server (Server) 40, a control apparatus 20 configured to control the packet processing apparatuses 10, and a plurality of path calculation apparatuses 50-1 to 50-3 each configured to calculate a packet forwarding path (hereinafter written as “path calculation apparatus 50” when no particular distinction among the path calculation apparatuses 50-1 to 50-3 is needed). A reference sign in each drawing appended to this overview is appended to each element for convenience, as an example for help understanding, and does not intend to limit the present invention to the mode that has been illustrated.

Each packet processing apparatus 10 processes a received packet, based on a processing rule notified from the control apparatus 20.

The control apparatus 20 functions as means for determining from among packet forwarding paths notified from the path calculation apparatus 50 the path of actually forwarding the packet and means for determining processing content (action) to be executed by the packet processing apparatus 10.

Each path calculation apparatus 50 functions as means for calculating the forwarding path, based on at least one policy for calculating the forwarding path, and notifying the calculated forwarding path to the control apparatus 20.

The path calculation apparatus 50 calculates the forwarding path of the packet, based on the at least one policy for calculating the forwarding path. The path calculation apparatuses 50 respectively calculate the forwarding paths, based on the policies that are mutually different, for example. To take an example, when the policies comprise policies A to E, the path calculation apparatus 50-1 calculates the forwarding path, based on the policy A. The path calculation apparatus 50-2 calculates the forwarding path, based on each of the policies B and C. The path calculation apparatus 50-3 calculates the forwarding path, based on each of the policies D and E.

The path calculation apparatuses 50 each calculate the forwarding path of the packet, based on the at least one policy notified from a policy notification apparatus (not illustrated), for example. The policy notification apparatus may be the control apparatus 20, for example.

Though a plurality of the path calculation apparatuses 50 are provided in FIG. 1, it is enough to provide at least one path calculation apparatus 50. The at least one path calculation apparatus 50 may calculate a plurality of forwarding paths for every plurality of policies.

The policy notification apparatus notifies at least one policy to each path calculation apparatus 50, for example. The policy notification apparatus may notify a plurality of policies to one path calculation apparatus 50. The policy notification apparatus performs policy notification so that the policies to be notified to the respective path control apparatuses 50 do not duplicate one another, for example. When the policies comprise the policies A to E, for example, the policy notification apparatus notifies the policy A to the path calculation apparatus 50-1, notifies the policy B and the policy C to the path calculation apparatus 50-2, and notifies the policy D and the policy E to the path calculation apparatus 50-3.

The policy notification apparatus may change the at least one policy to be notified to each path calculation apparatus 50 every time the policy notification apparatus notifies the at least one policy to the path calculation apparatus 50. The policy notification apparatus may notify the policy B and the policy C to the path calculation apparatus 50-1 to which the policy notification apparatus has notified the policy A, when performing subsequent policy notification.

When each path calculation apparatus 50 stores the plurality of policies, the policy notification apparatus may specify one or more of the plurality of policies for calculating the forwarding paths, instead of notifying the at least one policy. The path calculation apparatus 50 calculates one or more of the forwarding paths of the packet, based on the specified one or more of the plurality of policies stored in the path calculation apparatus 50.

The path calculation apparatus 50 calculates the forwarding path of the packet, based on the policy assigned in advance, for example. At least one policy may be used as the policy assigned to the path calculation apparatus 50 in advance. The policies that are different to one another are assigned to the respective path calculation apparatuses 50 in advance. When the policies comprise the policies A to E, for example, the policy A is assigned to the path calculation apparatus 50-1 in advance, the policy B and the policy C are assigned to the path calculation apparatus 50-2 in advance, and the policy D and the policy E are assigned to the path calculation apparatus 50-3 in advance.

The path calculation apparatuses 50 may be provided, respectively, for a plurality of policies, for example. In this case, one of the plurality of policies is assigned to each of the path calculation apparatuses 50. The path calculation apparatus 50 calculates the forwarding path of the packet, based on the assigned policy.

One of the plurality of policies is a policy of calculating a packet forwarding path using a shortest path, for example. One of the plurality of policies is a policy of calculating a forwarding path that minimizes an increase in network traffic. One of the plurality of policies is a policy of using the multi-hop Djikstra algorithm described in Patent Literature 1 to calculate a plurality of forwarding paths each including the shortest path, for example. One of the plurality of policies is calculating a shortest path tree from a certain communication terminal to a plurality of communication terminals in order to use the shortest path tree as a multi-cast tree, for example. One of the plurality of policies is a policy of calculating a forwarding path so that the number of paths per forwarding node is averaged over an entire network, for example. The plurality of policies are not limited to these examples. Any policy that is used for calculating a packet forwarding path may be used for the plurality of policies.

In the above-mentioned configuration, the plurality of the path calculation apparatuses each configured to calculate a packet forwarding path, based on at least one of the plurality of policies are provided, and the plurality of the path calculation apparatuses are dispersedly disposed to calculate forwarding paths. Thus, an increase in processing load of each apparatus configured to perform path calculation can be avoided while improving flexibility of flow control.

### First Exemplary Embodiment

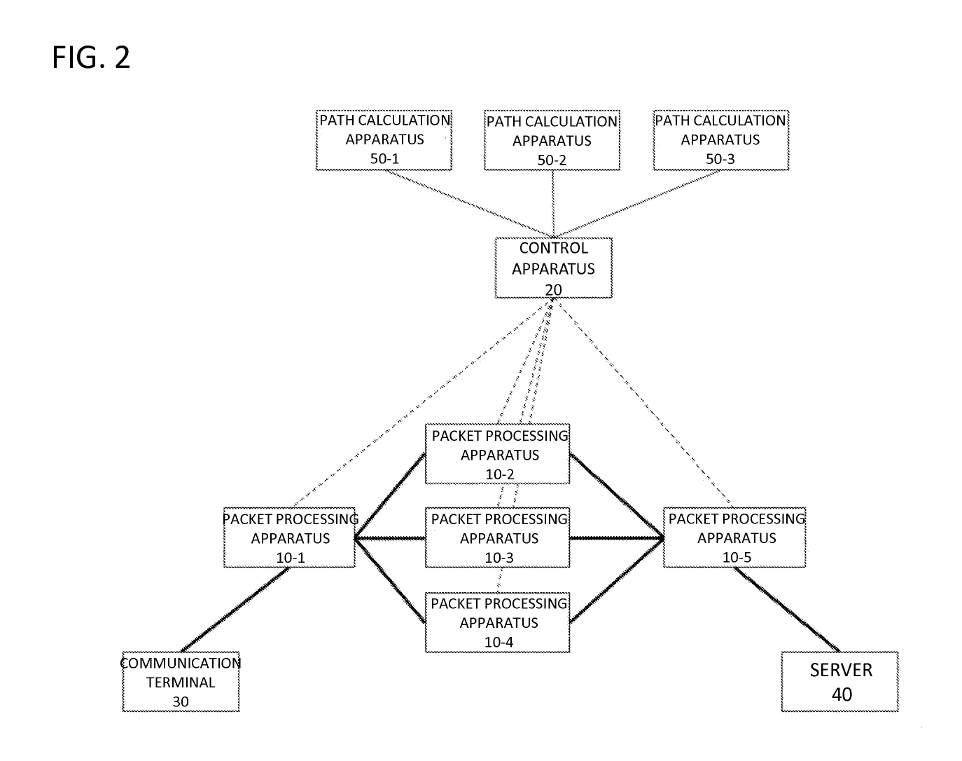

A description will be given about a first exemplary embodiment of the present invention, with reference to the drawings. In the first exemplary embodiment, each path calculation apparatus is notified of at least one policy and calculates a packet forwarding path, based on the notified at least one policy. FIG. 2 is a diagram illustrating an example of a configuration of a communication system according to the first exemplary embodiment. Referring to FIG. 2, the configuration is illustrated which includes packet processing apparatuses 10 configured to implement communication between a communication terminal 30 and a server (Server) 40, a control apparatus 20 configured to control these packet processing apparatuses 10, and path calculation apparatuses 50 configured to calculate forwarding paths for a packet according to the policies that are mutually different. In the example in FIG. 2, the communication system includes three path calculation apparatuses 50. The number of the path calculation apparatuses 50 is not, however, limited to three. Any number of the path calculation apparatuses 50 may be used.

The first exemplary embodiment is an example where the present invention is implemented by a technology referred to OpenFlow (OpenFlow), which is a network architecture of a centralized control type. Implementation of the present invention is not limited to implementation using OpenFlow. Any technology may be used for implementation if a network architecture of a centralized control type is used.

OpenFlow can identifies communications as end-to-end flows and can execute path control or the like on a per-flow basis. Each flow is a series of communication packets having a predetermined attribute (attribute to be identified based on the destination, the transmission source, or the like of a communication), for example.

In this exemplary embodiment, each packet processing apparatus 10 is a network switch adopting OpenFlow technology, for example. The control apparatus 20 is an information processing apparatus that controls the network switch adopting the OpenFlow technology, for example.

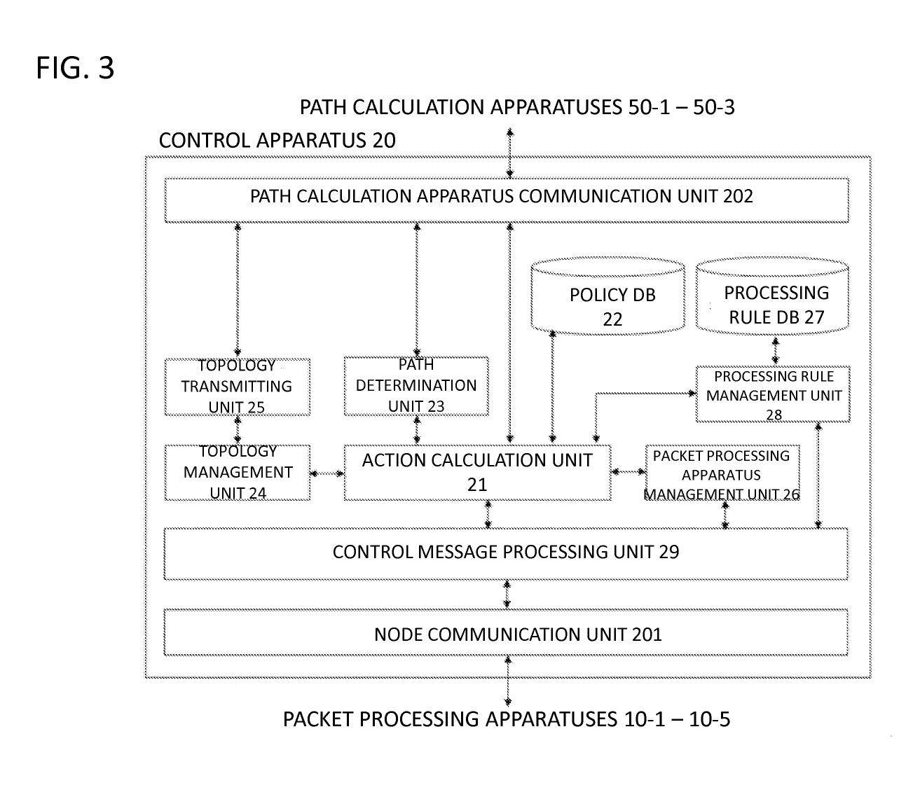

FIG. 3 is a block diagram illustrating an example of a configuration of the control apparatus 20. Referring to FIG. 3, the example of the configuration is illustrated which includes an action calculation unit 21, a policy DB (database) 22, a path determination unit 23, a topology management unit 24, a topology transmitting unit 25, a packet processing apparatus management unit 26, a processing rule database (processing rule DB) 27, a processing rule management unit 28, a control message processing unit 29, a node communication unit 201, and a path calculation apparatus communication unit 202. The control apparatus 20 may be configured by software such as an OS (Operating System) that runs on a server.

The action calculation unit 21 notifies at least one policy for calculating a forwarding path of a packet to each path calculation apparatus 50 by referring to the policy DB 22. The action calculation unit 21 may change the at least one policy to be notified to each path calculation apparatus 50 every time the action calculation unit 21 notifies the at least one policy, for example. The action calculation unit 21 notifies the at least one policy so that the policies to be notified to the respective path control apparatuses 50 do not duplicate one another. In the first exemplary embodiment, the control apparatus 20 performs policy notification to each path calculation apparatus 50. However, an apparatus that performs policy notification is not limited to the control apparatus 20, and the apparatus different from the control apparatus 20 may perform policy notification. When the at least one policy is assigned to each path calculation apparatus 50 in advance, the control apparatus 20 does not notify the at least one policy to the path calculation apparatus 50.

The action calculation unit 21 receives the forwarding paths calculated by the path calculation apparatuses 50-1 to 50-3 through the path calculation apparatus communication unit 202. The action calculation unit 21 makes an inquiry about the path for actually forwarding the packet among the received forwarding paths. When the forwarding path determined by the path determination unit 23 is notified, the action calculation unit 21 generates a processing rule for forwarding the packet through the determined forwarding path. The action calculation unit 21 notifies the generated processing rule to each packet processing apparatus 10.

The policy DB 22 stores the at least one policy for calculating the forwarding path of the packet.

The path determination unit 23 functions as means for determining, from among the forwarding paths received by the action calculation unit 21, the path for actually forwarding the packet. With respect to a method of determining the path for actually forwarding the packet by the path determination unit 23, any method may be used if the method is the one of determining at least one path from among the forwarding paths.

The topology management unit 24 constructs network topology information, based on a connection relationship among the packet processing apparatuses 10 collected through the node communication unit 201. To take an example, the topology management unit 24 collects information on the connection relationship among the packet processing apparatuses 10 from the packet processing apparatuses 10 to manage a network topology to be configured with the packet processing apparatuses 10. The topology management unit 24 manages the network topology, using an LLDP (Link Layer Discovery Protocol), for example. Each packet processing apparatus 10 performs information exchange with an adjacent apparatus on a network, using the LLDP. The packet processing apparatus 10 performs information exchange with the adjacent apparatus based on the LLDP, thereby collecting reachability (Reachability) with the adjacent apparatus and connected apparatus information. The packet processing apparatus 10 transmits the collected information to the topology management unit 24. The topology management unit 24 grasps the network topology, based on the information transmitted from the packet processing apparatuses 10.

When a change in the topology information occurs, the topology management unit 24 may notify the change in the topology information to the action calculation unit 21 and may cause the action calculation unit 21 to reset one or more existing processing rules. The change in the topology information occurs when the packet processing apparatus 10 is added or deleted, for example. The change in the topology information occurs when the packet processing apparatus 10 cannot be used due to a failure or the like, for example. The change in the topology information occurs when the packet processing apparatus 10 is powered on or off, for example. The change in the topology information occurs due to a cable disconnection or connection between the packet processing apparatuses 10, for example.

The packet processing apparatus management unit 26 manages the ability of each packet processing apparatus 10 to be managed (such as the number and type of ports and the type of an action to be supported).

The processing rule database (processing rule DB) 27 stores a result of calculation by the action calculation unit 21 as the processing rule.

The processing rule management unit 28 manages the processing rule set in each packet processing apparatus 10. Specifically, the processing rule management unit 28 stores the result calculated by the action calculation unit 21 in the processing rule DB 27 as the processing rule, and updates content of the processing rule DB 27 also when a change in the processing rule set in each packet processing apparatus 10 has occurred due to notification of deletion of the processing rule from the packet processing apparatus 10 or the like.

The control message processing unit 29 receives a request for setting the processing rule from one of the packet processing apparatus 10 through the node communication unit 201. When receiving the request for the processing rule, the control message processing unit 29 requests each path calculation apparatus 50 to calculate the forwarding path of the packet through the path calculation apparatus communication unit 202.

The node communication unit 201 functions as means for performing communication with each packet processing apparatus 10.

The path calculation apparatus communication unit 202 functions as means for performing communication with each path calculation apparatus 50.

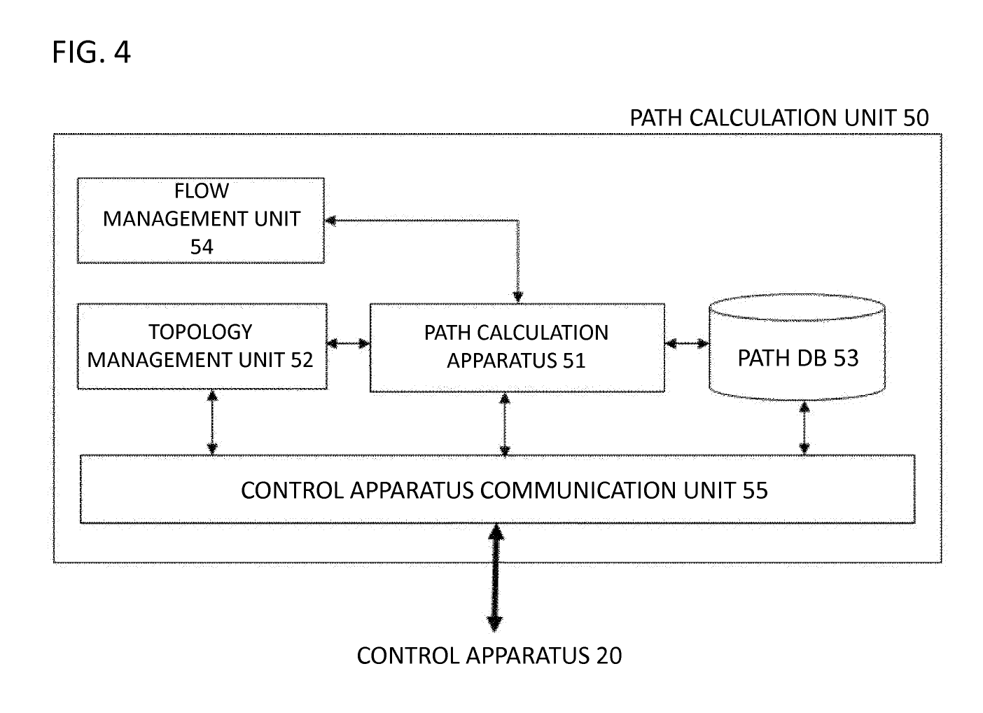

FIG. 4 is a block diagram illustrating a configuration example of each path calculation apparatus 50. Referring to FIG. 4, the path calculation apparatus 50 includes a path calculation unit 51, a topology management unit 52, a path database (path DB) 53, a flow management unit 54, and a control apparatus communication unit 55.

The path calculation apparatuses 50 and the control apparatus 20 can be configured to operate on a same server, for example. The path calculation apparatuses 50 and the control apparatus 20 can be configured to operate on servers that are different from each other, for example.

The path calculation unit 51 functions as means for calculating the forwarding path of the packet and notifying the calculated forwarding path to the control apparatus 20.

The path calculation unit 51 calculates the forwarding path of the packet, based on the at least one policy notified from the control apparatus 20, for example. The path calculation unit 51 calculates the forwarding path of the packet, based on each of a plurality of the policies when notified of the plurality of the policies from the control apparatus 20, for example.

The path calculation unit 51 calculates the forwarding path of the packet, in response to a request from the control apparatus 20, for example.

The path calculation unit 51 calculates the forwarding path of the packet in response to receipt of notification of a change in the topology information from the topology management unit 52, for example. In this case, the path calculation unit 51 may extract a forwarding path for which recalculation is necessary due to the change in the topology information by referring to existing forwarding paths stored in the path DB 53. The path calculation unit 51 may calculate the forwarding path that is new and is for the packet that has been forwarded through the extracted forwarding path, for example. The path calculation unit 51 may obtain information on the packet that has been forwarded through the extracted forwarding path, by referring to the flow management unit 54.

The path calculation unit 51 calculates the forwarding path of the packet, in response to a request from a user, for example. The path calculation unit 51 calculates the forwarding path of the packet in response to detection of abnormality of traffic in the network (such as a case where traffic concentration has occurred). The path calculation unit 51 calculates the forwarding path of the packet in response to detection of an increase in processing load of the packet processing apparatus, for example. The path calculation unit 51 calculates the forwarding path of the packet at a predetermined interval, for example.

When calculating the forwarding path of the packet, the path calculation unit 51 may request the control apparatus 20 to notify the policy before calculation, for example. The control apparatus 20 notifies the at least one policy for calculating the forwarding path, in response to the request for the policy from the path calculation unit 51.

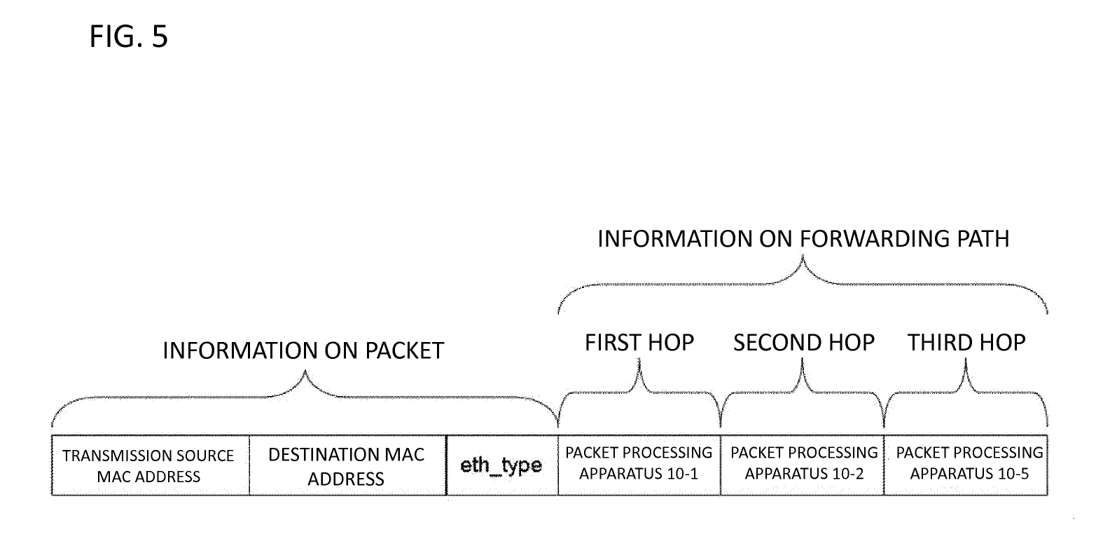

FIG. 5 illustrates an example of the forwarding path to be notified to the control apparatus 20 by the path calculation apparatus 50. The forwarding path calculated by the path calculation unit 51 includes information on the packet and information on the path for forwarding the packet, for example. The information on the packet is information stored in the header of the packet, for example, and comprises a destination MAC (Media Access Control) address and a transmission source MAC address, for example. The information on the packet is not limited to these examples, and may be any information of identifiers whereby the packet can be identified, such as a destination IP (Internet Protocol) address and a transmission source IP address, or TCP (Transmission Control Protocol)/UDP (User Datagram Protocol) port numbers.

The information on the path for forwarding the packet is an identifier of one or more of the packet processing apparatuses 10 through which the packet passes. As illustrated in FIG. 5, the information on the path for forwarding the packet comprises an identifier for the packet processing apparatus 10-1 as the destination of a first hop of the packet, an identifier for the packet processing apparatus 10-2 as the destination of a second hop of the packet, and an identifier for the packet processing apparatus 10-5 as the destination of a third hop of the packet. The information on the path for forwarding the packet is not limited to these information, and any information whereby the packet forwarding path can be identified may be used.

The path calculation unit 51 notifies the calculated forwarding path to the control apparatus 20 through the control apparatus communication unit 55. The path calculation unit 51 may include an identifier for the path calculation apparatus 50 in information on the forwarding path to be notified to the control apparatus 20. With this arrangement, the control apparatus 20 can associate and store the forwarding path notified from the path calculation apparatus 50 and the path calculation apparatus 50 that has notified the forwarding path. Any information whereby the path calculation apparatuses 50 can be identified one another may be used for the identifier for the path calculation apparatus 50.

The topology management unit 52 manages the network topology information notified from the control apparatus 20. When a change in the topology information occurs, the topology management unit 52 may notify the change in the topology information to the path calculation unit 51, and may cause the path calculation unit 51 to perform recalculation with respect to the existing forwarding path.

The path database (path DB) 53 stores the information on the forwarding path calculated by the path calculation unit 51, for example. The path DB 53 may store the information on the forwarding path determined as the path for actually forwarding the packet by the control apparatus 20, for example. In this case, the path DB 53 receives from the control apparatus 20 the information on the determined forwarding path.

The flow management unit 54 stores the information on the packet whose forwarding path has been calculated by the path calculation unit 51. The information to be stored by the flow management unit 54 is information stored in the header of the packet whose forwarding path has been calculated by the path calculation unit 51, and wholly or partially comprises the destination MAC address, the transmission source MAC address, the destination IP address, the transmission source IP address, the TCP/UDP port numbers, and so forth. The information on the packet is not limited to these information. Any information on an identifier whereby the packet can be identified may be used.

The control apparatus communication unit 55 functions as means for performing communication with the control apparatus 20.

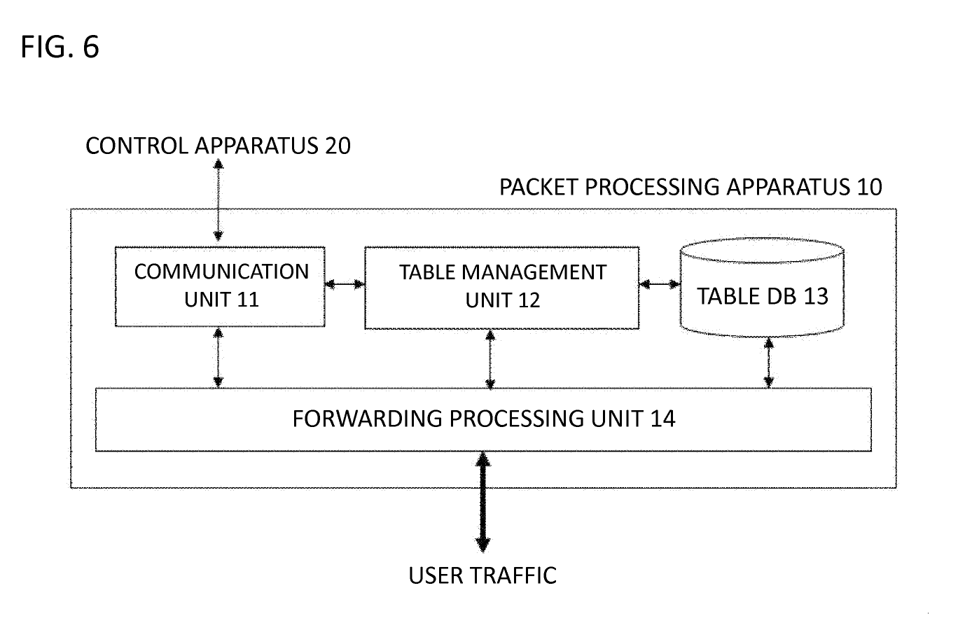

FIG. 6 is a block diagram illustrating a configuration example of each packet processing apparatus 10. Referring to FIG. 6, the packet processing apparatus 10 includes a communication unit 11, a table management unit 12, a table database (table DB) 13, and a forwarding processing unit 14. The packet processing apparatus 10 is a switch, a router, or the like, for example. The packet processing apparatus 10 may be a virtual switch that operates as software on a server, for example.

The communication unit 11 functions as means for implementing communication with the control apparatus 20 configured to set the processing rule in the packet processing apparatus 10.

The table management unit 12 is means for managing a table held in the table database (table DB) 13. The table management unit 12 registers the processing rule instructed by the control apparatus 20 in the table DB 13. When notified of receipt of a new packet from the forwarding processing unit 14, the table management unit 12 requests setting of a processing rule to the control apparatus 20.

The table database (table DB) 13 comprises a database capable of storing at least one table to be referred to when the forwarding processing unit 14 processes the received packet.

The forwarding processing unit 14 functions as table searching means for searching the table stored in the table DB 13 for the processing rule having a match field that matches the received packet and action execution means for processing the packet according to processing content given in the action field of the processing rule searched for by the table searching means. When the processing rule having the match field that matches the received packet is not found, the forwarding processing unit 14 notifies the fact to the table management unit 12.

Each unit (processing means) of the control apparatus 20, the path calculation apparatus 50, and the packet processing unit 10 illustrated in FIGS. 3, 4, and 6 can also be implemented by a computer program configured to cause a computer constituting these apparatuses to execute each process described above, using hardware of the computer.

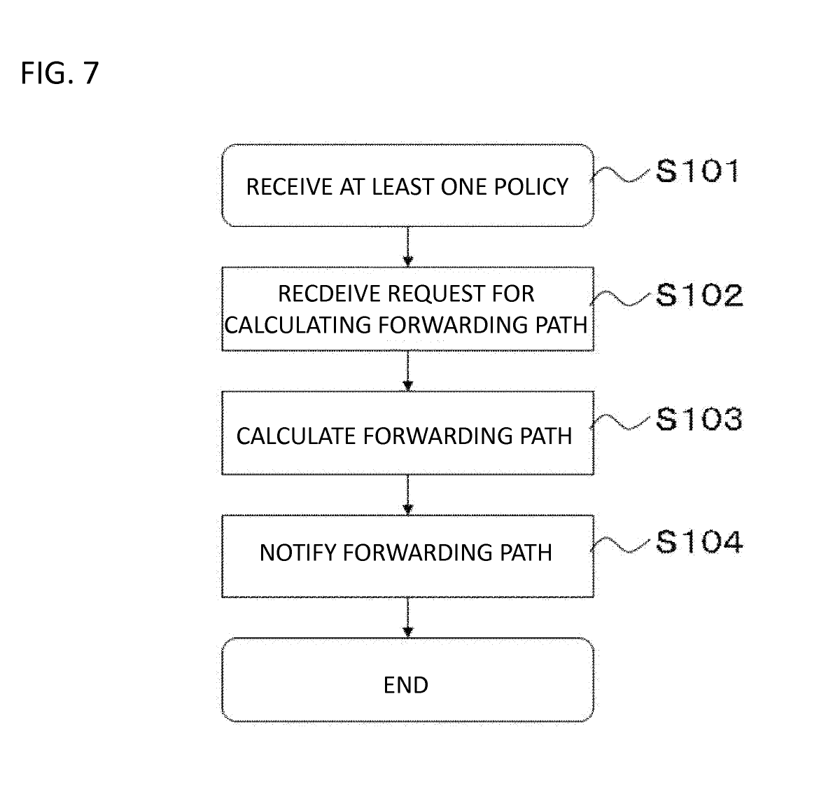

Next, an example of operation of each path calculation apparatus 50 in this exemplary embodiment will be described, with reference to the drawing. FIG. 7 is a flowchart for explaining the operation of the path calculation apparatus 50 according to this exemplary embodiment. FIG. 7 is given for exemplification, and the operation of the path calculation apparatus 50 of the present invention is not limited to the flowchart in FIG. 7. It is assumed that in the example in FIG. 7, no processing rule for implementing communication between the communication terminal 30 and the server 40 is set in the initial state of each of the packet processing apparatuses 10-1 to 10-5.

Referring to FIG. 7, the path calculation unit 51 receives from the control apparatus 20 at least one policy for calculating a forwarding path of a packet (in step S101 in FIG. 7).

Next, the path calculation unit 51 receives from the control apparatus 20 a request for calculating the forwarding path of the packet (in step S102 in FIG. 7).

Next, the patch calculation unit 51 calculates the forwarding path for forwarding the packet, based on the at least one policy notified from the control apparatus 20 (in step S103 in FIG. 7). The path calculation unit 51 of the patch calculation apparatus 50-1 calculates a first forwarding path for forwarding the packet through the packet processing apparatus 10-2, for example. The path calculation unit 51 of the path calculation apparatus 50-2 calculates a second forwarding path for forwarding the packet through the packet processing apparatus 10-3, for example. The packet calculation unit 51 of the path calculation apparatus 50-3 calculates a third forwarding path for forwarding the packet through the packet processing apparatus 10-4, for example. Each path calculation apparatus 50 may calculate the forwarding path for forwarding the packet, based on each of a plurality of policies. In that case, each packet processing apparatus 50 calculates the forwarding paths.

Thereafter, the path calculation unit 51 notifies the calculated forwarding path to the control apparatus 20 through the control apparatus communication unit 55 (in step S104 in FIG. 7).

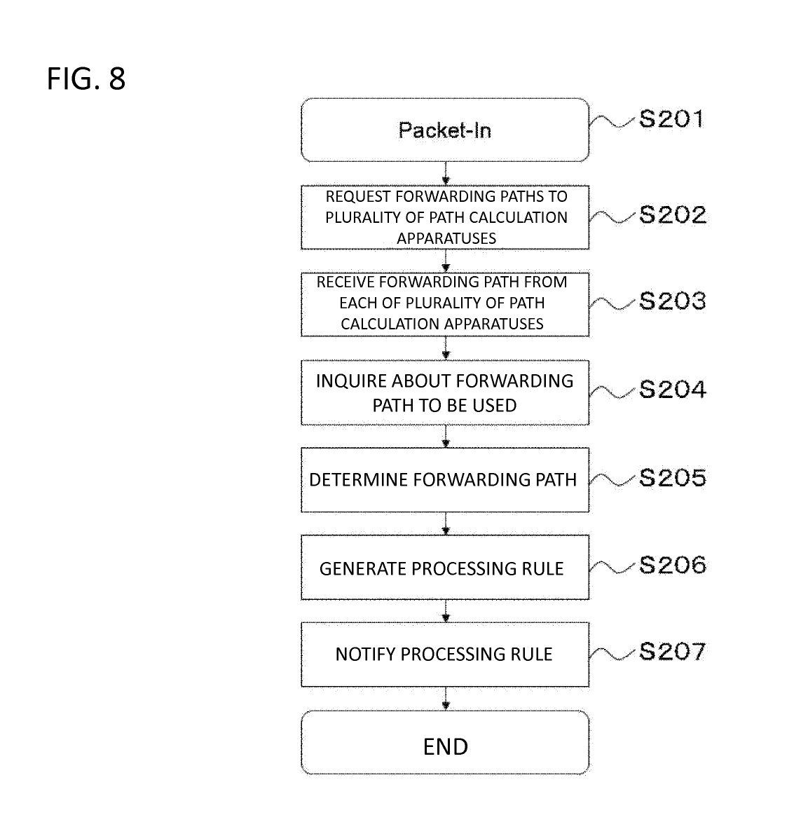

Next, an example of operation of the control apparatus 20 in this exemplary embodiment will be described, with reference to the drawing. FIG. 8 is a flowchart for explaining the operation of the control apparatus 20 according to this exemplary embodiment. FIG. 8 is given for exemplification, and the operation of the control apparatus 20 of the present invention is not limited to the flowchart in FIG. 8. It is assumed that in the example in FIG. 8, no processing rule for implementing communication between the communication terminal 30 and the server (Server) 40 is set in the initial state of each of the packet processing apparatuses 10-1 to 10-5, as in the example in FIG. 7.

Referring to FIG. 8, the control message processing unit 29 of the control apparatus 20 receives from the packet processing apparatus 10-1 a request for setting the processing rule through the node communication unit 201 (in step S201 in FIG. 8: Packet-In).

The control message processing unit 29 requests setting of a processing rule to each path calculation apparatus 50 through the path calculation apparatus communication unit 202 (in step S202 in FIG. 8).

The action calculation unit 21 receives from each of the path calculation apparatuses 50-1 to 50-3 the forwarding path of the packet (in step S203 in FIG. 8). The action calculation unit 21 receives the first forwarding path for forwarding the packet through the packet processing apparatus 10-2, the second forwarding path for forwarding the packet through the packet processing apparatus 10-3, and the third forwarding path for forwarding the packet through the packet processing apparatus 10-4, for example.

The action calculation unit 21 makes an inquiry to the path determination unit 23 about the path for actually forwarding the packet among the received forwarding paths (in step S204 in FIG. 8).

The path determination unit 23 determines the path for actually forwarding the packet from among the forwarding paths (in step S205 in FIG. 8). The path determination unit 23 determines the first forwarding path for forwarding the packet through the packet processing apparatus 10-2 as the path for actually forwarding the packet, for example.

The action calculation unit 21 determines the processing rule to be executed by each packet processing apparatuses 10 so as to forward the packet through the forwarding path determined by the path determination unit 23 (in step S206 in FIG. 8). The action calculation unit 21 determines the processing rule to be executed by each of the packet processing apparatuses 10-1, 10-2, and 10-5 so as to forward the packet through the first forwarding path, for example.

Thereafter, the action calculation unit 21 notifies the determined processing rule to each packet processing apparatus 10 through the node communication unit 201 (in step S207 in FIG. 8). The action calculation unit 21 notifies the calculated processing rule to each of the packet processing apparatuses 10-1, 10-2, and 10-5 through the node communication unit 201, for example.

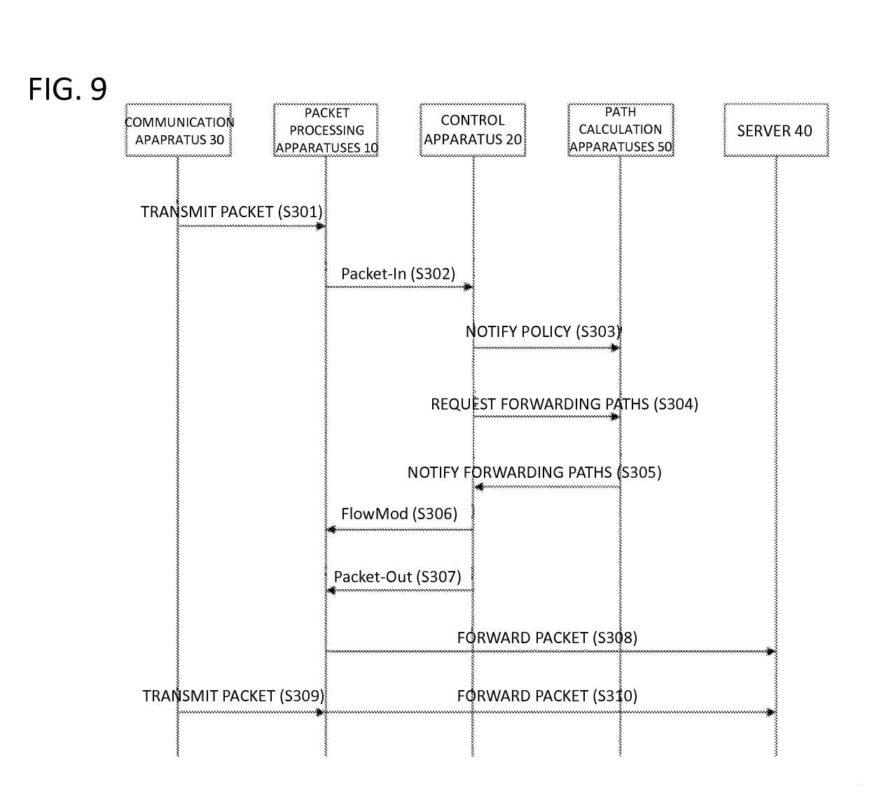

Subsequently, an example of operation of the communication system in this exemplary embodiment will be described with reference to the drawing. FIG. 9 is a sequence diagram for explaining the operation of the communication system according to this exemplary embodiment. FIG. 9 is given for exemplification, and the operation of the present invention is not limited to the sequence diagram in FIG. 9. It is assumed that in the example in FIG. 9, no processing rule for implementing communication between the communication terminal 30 and the server (Server) 40 is set in the initial state of each of the packet processing apparatuses 10-1 to 10-5, as in the examples in FIGS. 7 and 8.

Referring to FIG. 9, the communication terminal 30 first transmits a user packet to the server (Server) 40 (in step S301 in FIG. 9).

The packet processing apparatus 10-1 that has received the user packet searches the table DB 13 for s processing rule having a match field that matches the received packet. Since the processing rule is not found, the packet processing apparatus 10-1 transmits to the control apparatus 20 a request for setting the processing rule together with the received packet (in step S302 in FIG. 9: Packet-In).

The control apparatus 20 that has received the request for setting the processing rule notifies at least one policy to each of the path calculation apparatuses 50-1 to 50-3 (in step S303 in FIG. 9). A timing of notifying the at least one policy to each of the path calculation apparatuses 50-1 to 50-3 by the control apparatus 20 does not need to be after receipt of the request for setting the processing rule by the control apparatus 20, and the at least one policy may be notified to each of the path calculation apparatuses 50-1 to 50-3 in advance, for example.

Then, the control apparatus 20 requests the path calculation apparatuses 50-1 to 50-3 to calculate forwarding paths of the packet (in step S304 in FIG. 9).

The respective path calculation apparatuses 50-1 to 50-3 calculates the paths for forwarding the packet from the communication terminal 30 to the server (Server) 40 in response to the request for the calculation, and notifies the calculated forwarding paths to the control apparatus 20 (in step S305 in FIG. 9).

The control apparatus 20 that has received notification of the forwarding path of the packet determines the forwarding path for actually forwarding the packet from among the notified forwarding paths, generates the processing rule for forwarding the packet through the determined forwarding path, and sets the processing rule in each packet processing apparatus 10 (in step S306 in FIG. 9: FlowMod). The control apparatus 20 sets the processing rule for forwarding the packet addressed to the server (Sever) 40 by the communication terminal 30 through the packet processing apparatus 10-2 in each of the packet processing apparatuses 10-1, 10-2, and 10-5, for example.

The control apparatus 20 returns the packet received in step S302 to the packet processing apparatus 10-1 and instructs the packet processing apparatus 10-1 to forward the packet to the packet processing apparatus 10-2 (in step S307 in FIG. 9: Packet-Out).

When the packet processing apparatus 10-1 forwards the packet to the packet processing apparatus 10-2 based on the instruction, each of the packet processing apparatuses 10-2 and 10-5 forwards the packet to the server (Server) 40 according to the processing rule that has been set (in step S308 in FIG. 9).

Thereafter, each of the packet processing apparatuses 10-1, 10-2, and 10-5 forwards a user packet to be transmitted and received between the communication terminal 30 and the server (Server) 40 according to the processing rule that has been set (in steps S309 and S310 in FIG. 9).

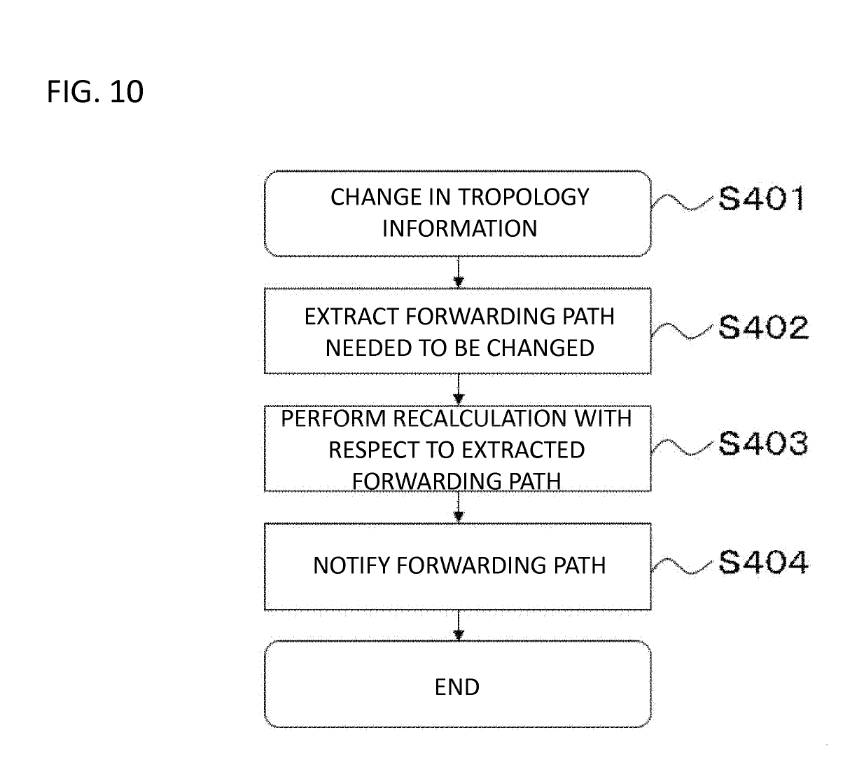

Next, a different example of the operation of each path calculation unit 50 in this exemplary embodiment will be described, with reference to the drawing. FIG. 10 is a flowchart for explaining the different example of the operation of the path calculation apparatus 50 according to this exemplary embodiment. FIG. 10 is given for exemplification, and the operation of the path calculation apparatus 50 of the present invention is not limited to the flowchart in FIG. 10.

The example in FIG. 10 is the one when the path calculation apparatus 50 resets the forwarding path of a packet according to a change in the network topology information. It is assumed that the processing rule is already set in the initial state of each of the packet processing apparatuses 10-1 to 10-5. It is assumed that in the example in FIG. 10, the processing rule for forwarding the packet transmitted by the communication terminal 30 and addressed to the server (Server) 40 through the packet processing apparatus 10-2 is set in each of the packet processing apparatuses 10-1, 10-2, and 10-5.

Referring to FIG. 10, when the change in the network topology information occurs, the topology management unit 52 of the path calculation apparatus 50 notifies the change in the topology information to the path calculation unit 51 (in step S401 in FIG. 10). When it becomes impossible to use the packet processing apparatus 10-2, for example, the topology management unit 52 notifies the change in the topology information, which is deletion of the packet processing apparatus 10-2, to the path calculation unit 51.

The path calculation unit 51 that has received the notification extracts the forwarding path needed to be changed, based on the notified change in the topology information and the existing forwarding paths stored in the path DB 53 (in step S402 in FIG. 10). The path calculation unit 51 extracts the forwarding path of the packet transmitted by the communication terminal 30 and addressed to the server (Server) 40, as the forwarding path needed to be changed, for example.

Then, the path calculation unit 51 calculates a new forwarding path of the packet forwarded through the extracted forwarding path (in step S403 in FIG. 10). The path calculation unit 51 may request notification of at least one policy to the control apparatus 20 before the path calculation unit 51 calculates the forwarding path. In this case, the path calculation unit 51 calculates the forwarding path, based on the at least one policy that has been newly notified. The path calculation unit 51 may refer to the flow management unit 54 to obtain information on the packet forwarded through the extracted forwarding path. The path calculation unit 51 of the path calculation apparatus 50-1 calculates a first forwarding path for forwarding the packet through the packet processing apparatus 10-3, for example. The path calculation unit 51 of the path calculation apparatus 50-2 calculates a second forwarding path for forwarding the packet through the packet processing apparatus 10-3, for example. The path calculation unit 51 of the path calculation apparatus 50-3 calculates a third forwarding path for forwarding the packet through the packet processing apparatus 10-4.

Thereafter, the path calculation unit 51 notifies the calculated forwarding path to the control apparatus 20 through the control apparatus communication unit 55 (in step S404 in FIG. 10).

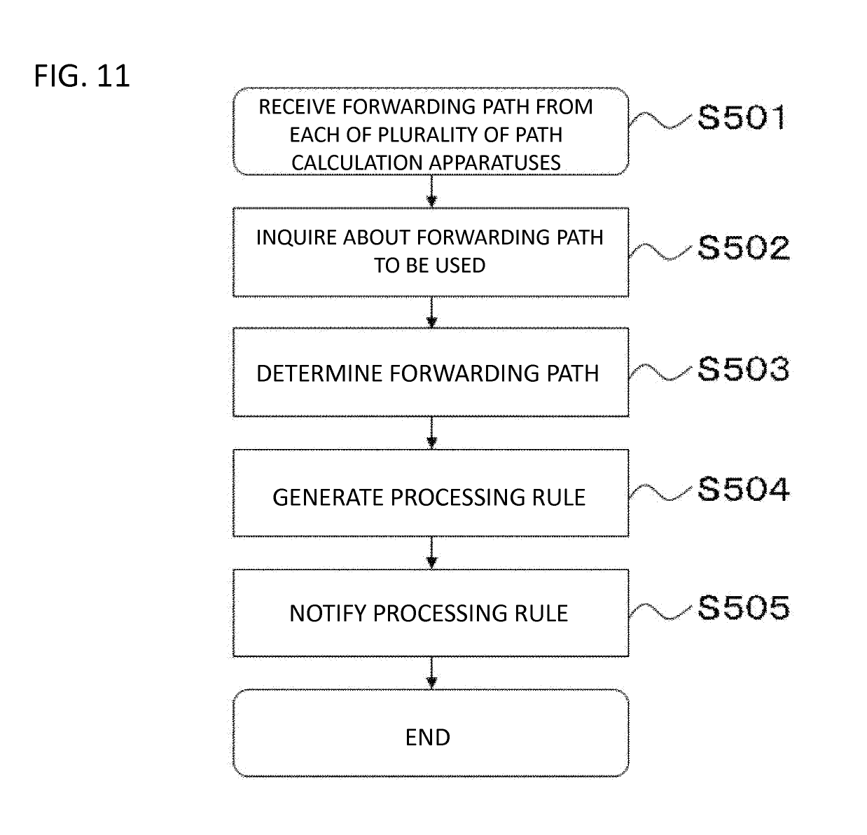

Next, a different example of the operation of the control apparatus 20 in this exemplary embodiment will be described with reference to the drawing. FIG. 11 is a flowchart for explaining the different operation example of the control apparatus 20 according to this exemplary embodiment. FIG. 11 is given for exemplification, and the operation of the control apparatus 20 of the present invention is not limited to the flowchart in FIG. 11.

The example in FIG. 11 is the one when the forwarding path of a packet is reset according to a change in the network topology information, as in the example in FIG. 10. It is assumed that the processing rule is already set in the initial state of each of the packet processing apparatuses 10-1 to 10-5.

Referring to FIG. 11, the action calculation unit 21 of the control apparatus 20 receives the forwarding path of the packet from each of the path calculation apparatuses 50 (in step S501 in FIG. 11).

Then, the action calculation unit 21 makes an inquiry to the path determination unit 23 about the path for actually forwarding the packet among the forwarding paths that have been notified (in step S502 in FIG. 11).

The path determination unit 23 determines the path for actually forwarding the packet from among the forwarding paths (in step S503 in FIG. 11). The path determination unit 23 determines the forwarding path for forwarding the packet through the packet processing apparatus 10-3 as the packet for actually forwarding the packet, for example.

The action calculation unit 21 generates a processing rule to be executed by each of the packet processing apparatuses 10 in order to forward the packet through the forwarding path determined by the path determination unit 23 (in step S504 in FIG. 11). The action calculation unit 21 determines the processing rule to be executed by each of the packet processing apparatuses 10-1, 10-3, and 10-5 in order to forward the packet through each of the first and second forwarding paths, for example.

Thereafter, the action calculation unit 21 notifies the determined processing rule to each of the packet processing apparatuses 10 through the node communication unit 201 (in step S505 in FIG. 11). The action calculation unit 21 notifies the calculated processing rule to each of the packet processing apparatuses 10-1, 10-3, and 10-5 through the node communication unit 201.

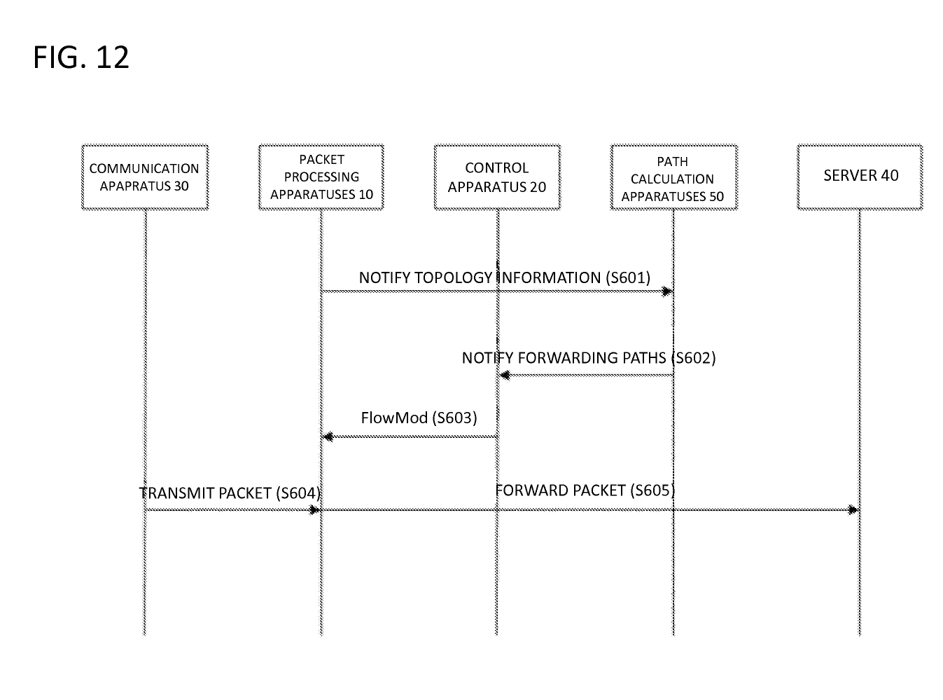

Next, a different example of the operation of the communication system in this exemplary embodiment will be described with reference to the drawing. FIG. 12 is a sequence diagram for explaining the operation of the communication system according to this exemplary embodiment. FIG. 12 is given for exemplification, and the operation of the present invention is not limited to the sequence diagram of FIG. 12.

The example in FIG. 12 is the one when each path calculation apparatus 50 resets the forwarding path of a packet according to a change in the network topology information, as in the examples in FIG. 10 and FIG. 11. It is assumed that the processing rule is already set in the initial state of each of the packet processing apparatuses 10-1 to 10-5.

Referring to FIG. 12, each packet processing apparatus 10 first notifies topology information to the path calculation apparatuses 50 (in step S601 in FIG. 12). The packet processing apparatus 10 may directly notify the topology information to the path calculation apparatuses 50.

When the change occurs in the network topology information, the path calculation apparatuses 50 recalculates forwarding paths of the packet, and notifies the recalculated forwarding paths to the control apparatus 20 (in step S602 in FIG. 12). To take an example, the path calculation apparatus 50-1 recalculates the first forwarding path through the packet processing apparatus 10-3 from the forwarding path through the packet processing apparatus 10-2 with respect to the packet transmitted from the communication terminal 30 and addressed to the server (Server) 40, according to the change in the topology information, which is deletion of the packet processing apparatus 10-2, and notifies the first forwarding path to the control apparatus 20. Similarly, the path calculation apparatus 50-2 recalculates the second forwarding path through the packet processing apparatus 10-3 from the forwarding path through the packet processing apparatus 10-2, and notifies the second forwarding path to the control apparatus 20, for example. The path calculation apparatus 50-3 recalculates the third forwarding path through the packet processing apparatus 10-4 from the forwarding apparatus through the packet processing apparatus 10-2 and notifies the third forwarding path to the control apparatus 20, for example.

The control apparatus 20 that has received the recalculated forwarding paths determines the path for actually forwarding the packet, generates a processing rule associated with the determined forwarding path, and notifies the processing rule to each of the packet processing apparatuses 10 (in step S603 in FIG. 12; FlowMod). The control apparatus 20 determines the forwarding path through the packet processing apparatus 10-3 as the path for actually forwarding the packet, and sets the processing rule in each of the packet processing apparatuses 10-1, 10-3, and 10-5.

The communication terminal 30 transmits the packet of a user to the server (Server) 40 (in step S604 in FIG. 12).

The packet processing apparatus 10-1 that has received the user packet searches the processing rule DB 13 for the processing rule having a match field that matches the received packet, and forwards the packet to the packet processing apparatus 10-3 according to the processing rule set by the control apparatus 20. When the packet processing apparatus 10-1 forwards the packet to the packet processing apparatus 10-3, each of the packet processing apparatuses 10-3 and 10-5 forwards the packet to the server (Server) 40 according to the processing rule set in each of the packet processing apparatuses 10-3 and 10-5 (in step S605 in FIG. 12).

In the configuration as mentioned above, the path calculation apparatuses each configured to calculate the packet forwarding path based on the at least one policy are provided. Then, the path calculation apparatuses are dispersedly disposed to perform forwarding path calculation. Thus, an increase in processing load of each apparatus configured to perform path calculation can be avoided while improving flexibility of flow control. Further, each path calculation apparatus calculates the packet forwarding path. Thus, the control apparatus configured to generate a processing rule does not need to perform path calculation, so that an increase in processing load of the control apparatus can be avoided.

### Second Exemplary Embodiment

A description will be directed to a second exemplary embodiment, with reference to the drawing. In the second exemplary embodiment, each path calculation apparatus stores a plurality of policies and calculates a packet forwarding path using a specified one of the stored policies. A description of configurations that are equivalent to those in the first exemplary embodiment will be omitted.

A control apparatus 20 and packet processing apparatuses 10 have same configurations as those in the first exemplary embodiment of the present invention.

An action calculation unit 21 of the control apparatus 20 specifies at least one of the plurality of policies for calculating the packet forwarding path for each pass calculation apparatus 50, by referring to a policy DB 22. In the second exemplary embodiment, the control apparatus 20 specifies the at least one policy for each path calculation apparatus 50. An apparatus configured to notify the at least one policy is not limited to the control apparatus 20, and the apparatus different from the control apparatus 20 may be used to notify the at least one policy. The action calculation unit 21, for example, notifies the at least one policy so that the at least one policies to be notified to the respective path control apparatuses 50 do not duplicate one another. The action calculation unit 21 may change the at least one policy to be specified for each path calculation apparatus 50 every time the at least one policy is notified, for example.

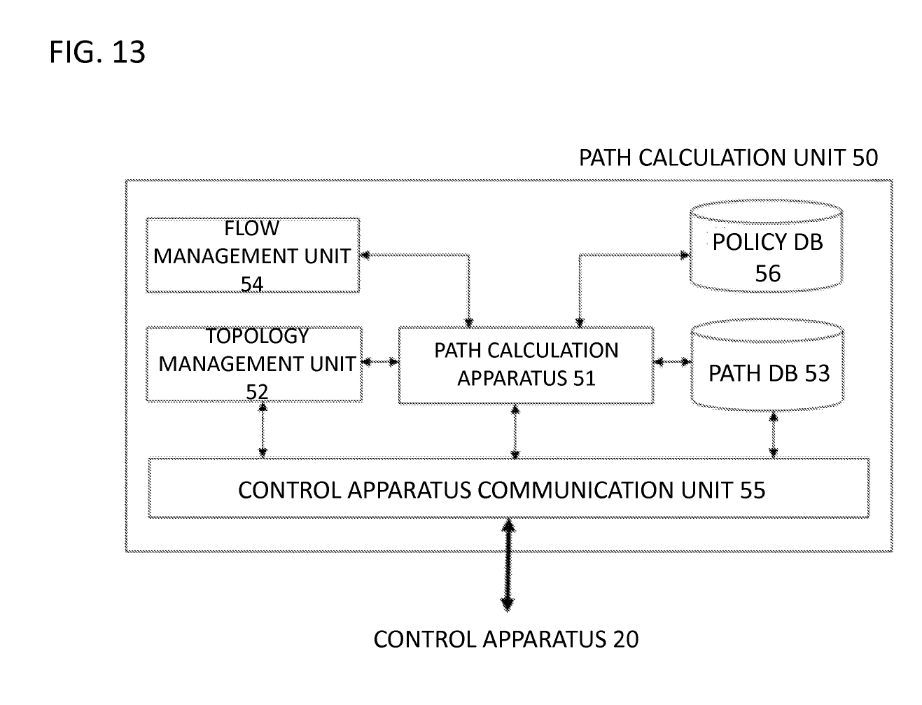

FIG. 13 is a diagram illustrating a configuration example of each path calculation apparatus 50 in the second exemplary embodiment of the present invention. Referring to FIG. 13, the path calculation apparatus 50 includes a policy database (policy DB) 56.

The path calculation apparatus 50 includes a path calculation unit 51, a topology management unit 52, a path database (path DB) 53, a flow management unit 54, and a control apparatus communication unit 55 that function as means which are the same as those in the above-mentioned first exemplary embodiment.

The policy DB 56 stores the plurality of policies for calculating the packet forwarding path. The policy DB 56 may be regularly notified of the plurality of policies from the control apparatus 20, for example.

The path calculation unit 51 refers to the policy DB 56 to calculate the packet forwarding path, based on the at least one policy specified from the control apparatus 20. When a plurality of the policies are specified from the control apparatus 20, the path calculation unit 51 calculates the packet forwarding path, based on each of the specified policies.

The path calculation unit 51 calculates the packet forwarding path in response to a request from the control apparatus 20, for example. The path calculation unit 51 calculates the packet forwarding path in response to receipt of notification of a change in topology information from the topology management unit 52, for example.

When the path calculation unit 51 calculates the packet forwarding path, the path calculation unit 51 may request the control apparatus 20 to specify one or more of the policies before calculation, for example. The control apparatus 20 specifies the at least one policy for calculating the forwarding path, in response to the request for the one or more of the policies from the path calculation unit 51.

Operation examples of the control apparatus 20, each path calculation apparatus 50, and a communication system are similar to the operation examples in the first exemplary embodiment. The control apparatus 20 specifies the at least one of the plurality of policies for calculating the packet forwarding path, for each path calculation apparatus 50.

In the configuration as mentioned above, the path calculation apparatuses each configured to calculate the packet forwarding path based on the at least one policy are provided. Then, the path calculation apparatuses are dispersedly disposed to perform forwarding path calculation. Thus, an increase in processing load of each apparatus configured to perform path calculation can be avoided while improving flexibility of flow control. Further, each path calculation apparatus calculates the packet forwarding path. Thus, the control apparatus configured to generate a processing rule does not need to perform path calculation, so that an increase in processing load of the control apparatus can be avoided.

### Third Exemplary Embodiment

A description will be directed to a third exemplary embodiment of the present invention with reference to the drawing. In the third exemplary embodiment, from among a plurality of forwarding paths notified from path calculation apparatuses, a path for forwarding a packet is determined, based on a predetermined condition. This exemplary embodiment is different from the first and second exemplary embodiments in the configuration of a control apparatus. Since the other configurations are equivalent to those in the first and second exemplary embodiments, the following description will be given, focusing on the difference.

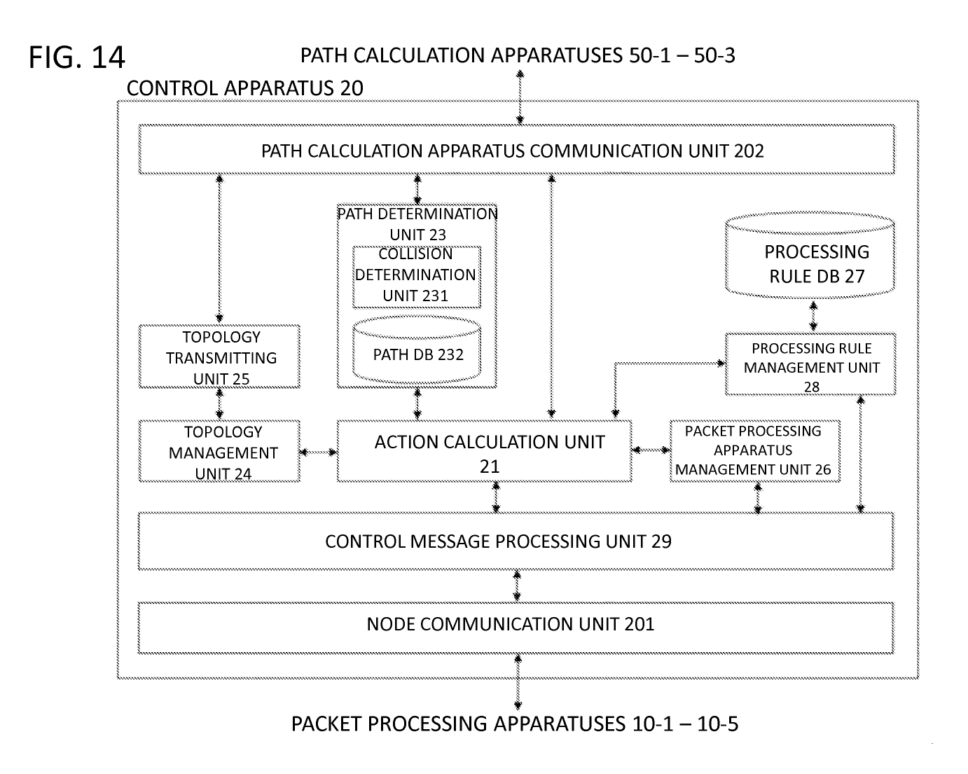

FIG. 14 is a block diagram illustrating an example of the configuration of the control apparatus 20. Referring to FIG. 14, a path determination unit 23 includes a collision determination unit 231 and a path database (path DB) 232.

The control apparatus 20 functions as means similar to that in each of the above-mentioned first and second exemplary embodiments. The control apparatus 20 includes an action calculation unit 21, a path calculation apparatus communication unit 202, a topology management unit 24, a packet processing apparatus management unit 26, a processing rule database (processing rule DB) 27, a processing rule management unit 28, a control message processing unit 29, and a node communication unit 201.

The collision determination unit 231 functions as means for determining, from among the plurality of forwarding paths received by the action calculation unit 21, the path for actually forwarding the packet. The collision determination unit 231 may refer to information on existing forwarding paths stored in the path DB 232 when determining the path for actually forwarding the packet.

The collision determination unit 231 selects the forwarding path that does not duplicate any forwarding path which has been already set, for example. The collision determination unit 231 can avoid concentration of traffic on a specific link and a specific node by selecting the forwarding path that does not duplicate any existing forwarding path.

When there are the forwarding paths that duplicate each other in the calculated forwarding paths, for example, the collision determination unit 231 may preferentially select the duplicate forwarding path. By selecting the duplicate forwarding path by the collision determination unit 231, the packet can be forwarded through the forwarding path that satisfies a plurality of policies.

The collision determination unit 231 may select the forwarding path that has been calculated earliest from among the calculated forwarding paths, for example. By selecting the forwarding path that has been calculated earliest by the collision determination unit 231, the time needed for setting the forwarding path of the packet can be shortened.

The collision determination unit 231 provides a priority for each path calculation apparatus 50, and selects the forwarding path calculated by the path forwarding apparatus 50 with a high priority, for example.

The collision determination unit 231 may determine the path for actually forwarding the packet, using any method of determining at least one of the plurality of forwarding paths.

The path database (path DB) 232 stores information on the forwarding path determined by the collision determination unit 231 as the path for actually forwarding the packet.

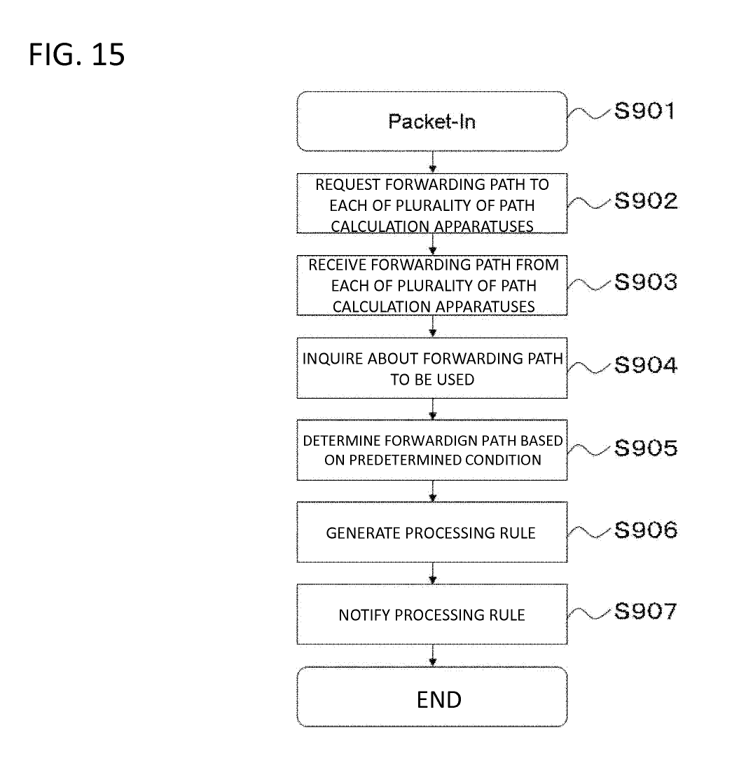

Next, an example of operation of the control apparatus 20 in the third exemplary embodiment of the present invention will be described with reference to the drawing. FIG. 15 is a flowchart for explaining the operation of the control apparatus 20 according to the third exemplary embodiment. FIG. 15 is given for exemplification, and the operation of the control apparatus 20 according to the third exemplary embodiment is not limited to the flowchart of FIG. 15. In the example in FIG. 15, it is assumed that no processing rule for implementing communication between a communication terminal 30 and a server (Server) 40 is set in the initial state of each of packet processing apparatuses 10-1 to 10-5.

Referring to FIG. 15, the control message processing unit 29 of the control apparatus 20 receives a request for setting a processing rule from the packet processing apparatus 10-1 through the node communication unit 201 (in step S901 in FIG. 15: Packet-In).

The control message processing unit 29 notifies the request for setting the processing rule to each of path calculation apparatuses 50 through a path calculation apparatus communication unit 202 (in step S902 in FIG. 15).

The action calculation unit 21 receives a packet forwarding path from each of path calculation apparatuses 50-1 to 50-3 (in step S903 in FIG. 15). The action calculation unit 21 receives a first forwarding path for forwarding the packet through the packet processing apparatus 10-2, a second forwarding path for forwarding the packet through the packet processing apparatus 10-3, and a third forwarding path for forwarding the packet through the packet processing apparatus 10-4.

The action calculation unit 21 makes an inquiry to the path determination unit 23 about the path for actually forwarding the packet among the received forwarding paths (in step S904 in FIG. 15).

The collision determination unit 231 of the path determination unit 23 determines the path for actually forwarding the packet from among the forwarding paths received by the action calculation unit 21, based on a predetermined condition (in step S905 in FIG. 15). When there are the forwarding paths that duplicate each other are present in the calculated forwarding paths, for example, the collision determination unit 231 preferentially selects the duplicate forwarding path. The collision determination unit 231 determines the first forwarding path for forwarding the packet through the packet processing apparatus 10-2, for example, as the path for actually forwarding the packet.

The action calculation unit 21 determines the processing rule to be executed by each packet processing apparatus 10 in order to forward the packet through the forwarding path determined by the path determination unit 23 from among the calculated forwarding paths (in step S906 in FIG. 15). The action calculation unit 21 determines the processing rule to be executed by each of the packet processing apparatuses 10-1, 10-2, and 10-5 in order to forward the packet through the first forwarding path, for example.

Thereafter, the action calculation unit 21 notifies the determined processing rule to each packet processing apparatus 10 through the node communication unit 201 (in step S907 in FIG. 15). The action calculation unit 21 notifies the calculated processing rule to each of the packet processing apparatuses 10-1, 10-2, and 10-5 through the node communication unit 201, for example.

Operation examples of each path calculation apparatus 50 and the communication system in the third exemplary embodiment are similar to the operation examples of each path calculation apparatus 50 and the communication system in each of the first and second exemplary embodiments.

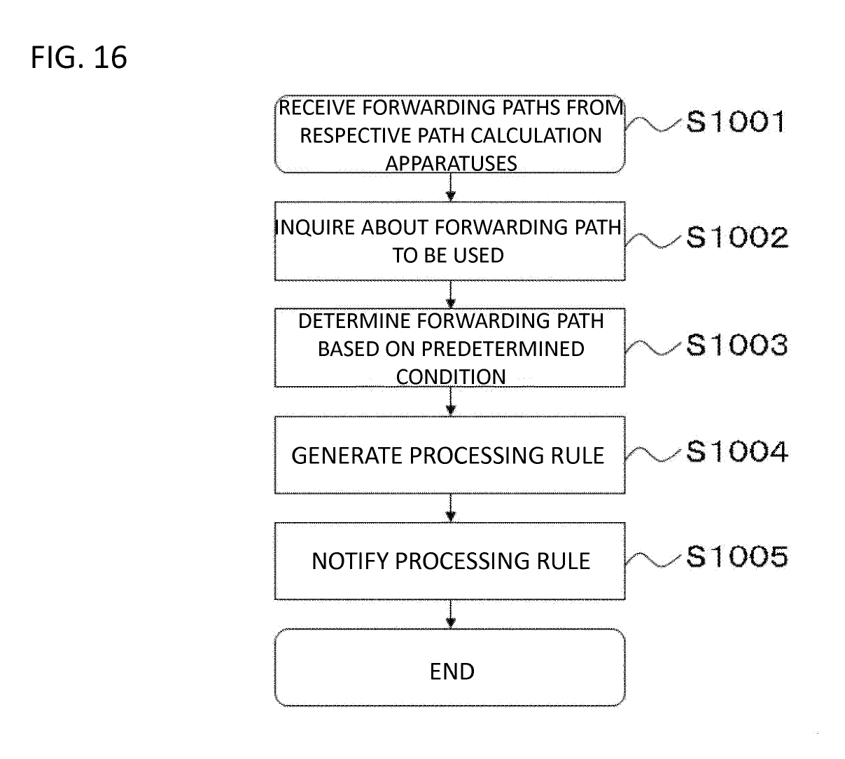

Next, a different example of the operation of the control apparatus 20 in the third exemplary embodiment of the present invention will be described with reference to the drawing. FIG. 16 is a flowchart for explaining the different example of the operation of the control apparatus 20 according to the third exemplary embodiment. FIG. 16 is given for exemplification, and the operation of the control apparatus 20 according to the third exemplary embodiment is not limited to the flowchart of FIG. 16. The example in FIG. 16 is the one when the forwarding path of a packet is reset according to a change in network topology information. It is assumed that the processing rule is already set in the initial state of each of the packet processing apparatuses 10-1 to 10-5.

Referring to FIG. 16, the action calculation unit 21 of the control apparatus 20 receives forwarding paths of the packet from the respective path calculation apparatuses 50 (in step S1001 in FIG. 16).

Next, the action calculation unit 21 makes an inquiry to the collision determination unit 231 of the path determination unit 23 about the path for actually forwarding the packet among the forwarding paths that have been notified (in step S1002 in FIG. 16).

The collision determination unit 231 of the path determination unit 23 determines the path for actually forwarding the packet from among the forwarding paths (in step S1003 in FIG. 16). The collision determination unit 231 determines the forwarding path for actually forwarding the packet through the packet processing apparatus 10-3, for example, as the path for actually forwarding the packet.

The action calculation unit 21 determines a processing rule to be executed by the packet processing apparatuses 10 through the forwarding path determined by the collision determination unit 231 (in step S1004 in FIG. 16). The action calculation unit 21 determines the processing rule to be executed by each of the packet processing apparatuses 10-1, 10-3, and 10-5 through each of the first and second forwarding paths, for example.

Thereafter, the action calculation unit 21 notifies the determined processing rule to each of the packet processing apparatuses 10 through the node communication unit 201 (in step S1005 in FIG. 16). The action calculation unit 21 notifies the calculated processing rule to each of the packet processing apparatuses 10-1, 10-3, and 10-5 through the node communication unit 201, for example.

Different operation examples of each path calculation apparatus 50 and the communication system in the third exemplary embodiment are similar to the different operation examples of each path calculation apparatuses 50 and the communication system in each of the first and second exemplary embodiments.

In the configuration as mentioned above, the control apparatus determines, from among the forwarding paths notified from the path calculation apparatuses, the path for forwarding the packet, based on the predetermined condition. Thus, the forwarding path of the packet can be flexibly determined, so that flexibility of flow control can be improved.

The following modes are possible in the present invention.

### (Mode 1)

A communication system, comprising:
a node that requests a processing rule for processing a packet;
a control apparatus that notifies a processing rule to the node in response to the request; and
a plurality of path calculation apparatuses that calculate a forwarding path of the packet received by the node, wherein
the plurality of path calculation apparatuses calculate the forwarding path based on at least one policy for calculating the forwarding path, and notifies the calculated forwarding path to the control apparatus, and the control apparatus generates based on one of a plurality of the notified forwarding paths the processing rule for forwarding the packet received by the node.

### (Mode 2)

The communication system according to mode 1, wherein
the plurality of path calculation apparatuses each calculate the forwarding path of the packet received by the node in response to a request from the control apparatus for the forwarding path of the packet.

### (Mode 3)

The communication system according to mode 1 or 2, wherein
the plurality of path calculation apparatuses recalculate a forwarding path of the packet received by the node in response to a change in a connection state of a plurality of nodes managed by the control apparatus.

### (Mode 4)

The communication system according to any one of modes 1 to 3, wherein
the control apparatus determines the forwarding path for forwarding the packet received by the node from among the plurality of notified forwarding paths based on a predetermined condition.

### (Mode 5)

The communication system according to mode 4, wherein
the control apparatus determines the forwarding path for forwarding the received packet by prioritizing forwarding paths that are duplicate in the plurality of notified forwarding paths.

### (Mode 6)

The communication system according to mode 4 or 5, wherein
the control apparatus determines the forwarding path for forwarding the packet received by the node from among a plurality of the calculated forwarding paths by prioritizing a forwarding path other than a forwarding path that has been determined as a forwarding path of another packet.

### (Mode 7)

A control apparatus, comprising:
first means that generates a processing rule for processing a packet received by a node, in response to a request from the node; and
second means that receives a plurality of forwarding paths of the packet from a plurality of path calculation apparatuses that calculate at least one of the forwarding paths of the packet received by the node based on at least one policy for calculating the at least one forwarding path,
wherein
the first means generates based on one of the plurality of forwarding paths received by the second means the processing rule for forwarding the packet received by the node.

### (Mode 8)

The control apparatus according to mode 7, comprising:
third means for determining the forwarding path for forwarding the packet received by the node from among the plurality of forwarding paths received by the second means based on a predetermined condition.

### (Mode 9)

The control apparatus according to mode 8, wherein
the third means determines the forwarding path for forwarding the packet received by the node by prioritizing forwarding paths that are duplicate in the plurality of received forwarding paths.

### (Mode 10)

The control apparatus according to mode 8 or 9, wherein
the third means determines the forwarding path for forwarding the packet received by the node from among the plurality of forwarding paths received by the second means by prioritizing a forwarding path other than a forwarding path that has been determined as a forwarding path of another packet.

### (Mode 11)

The control apparatus according to any one of modes 7 to 10, comprising:
fourth means that instructs the plurality of path calculation apparatuses to recalculate a forwarding path of the packet received by the node in response to a change in a connection state of a managed node(s),
wherein
the second means receives from the plurality of path calculation apparatuses a plurality of forwarding paths recalculated according to the instruction by the fourth means; and
the first means generates based on one of the plurality of recalculated forwarding paths received by the second means a processing rule for forwarding the packet received by the node.

### (Mode 12)

A communication control method, comprising:
generating a processing rule for processing a packet received by a node, in response to a request from the node;
receiving a plurality of forwarding paths of the packet from a plurality of path calculation apparatuses that calculate at least one of the plurality of forwarding paths of the packet received by the node based on at least one policy for calculating the at least one forwarding path; and
generating based on one of the plurality of received forwarding paths the processing rule for forwarding the packet received by the node.

### (Mode 13)

The communication control method according to mode 12, comprising: determining the forwarding path for forwarding the packet received by the node from among the plurality of received forwarding paths based on a predetermined condition.

### (Mode 14)

The communication control method according to mode 13, comprising: determining the forwarding path for forwarding the packet received by the node by prioritizing forwarding paths that are duplicate in the plurality of received forwarding paths.

### (Mode 15)

The communication control according to mode 13 or 14, comprising: determining the forwarding path for forwarding the packet received by the node from among the plurality of received forwarding paths by prioritizing a forwarding path other than a forwarding path that has been determined as a forwarding path of another packet.

### (Mode 16)

The communication control method according to any one of modes 12 to 15, comprising:
instructing the plurality of path calculation apparatuses to recalculate a forwarding path of the packet received by the node in response to a change in a connection state of a managed node(s);
receiving from the plurality of path calculation apparatuses a plurality of forwarding paths recalculated according to the instruction; and
generating based on one of the plurality of received recalculated forwarding paths a processing rule for forwarding the packet received by the node.

### (Mode 17)

A program, causing a control apparatus configured to control a node that processes a packet to execute:
generating a processing rule for processing the packet received by the node;
receiving a plurality of forwarding paths of the packet from a plurality of path calculation apparatuses that calculate at least one of the plurality of forwarding paths of the packet received by the node based on at least one policy for calculating the at least one forwarding path; and
generating based on one of the plurality of received forwarding paths the processing rule for forwarding the packet received by the node.

### (Mode 18)

The program according to mode 17, causing the control apparatus to execute:
determining the forwarding path for forwarding the packet received by the node from among the plurality of received forwarding paths based on a predetermined condition.

### (Mode 19)

The program according to mode 18, causing the control apparatus to execute:
determining the forwarding path for forwarding the packet received by the node by prioritizing forwarding paths that are duplicate in the plurality of received forwarding paths.

### (Mode 20)

The program according to mode 18 or 19, causing the control apparatus to execute:
determining the forwarding path for forwarding the packet received by the node from among the plurality of received forwarding paths by prioritizing a forwarding path other than a forwarding path that has been determined as a forwarding path of another packet.

### (Mode 21)

The program according to any one of modes 17 to 20, causing the control apparatus to execute:
instructing the plurality of path calculation apparatuses to recalculate a forwarding path of the packet received by the node in response to a change in a connection state of a managed node(s);
receiving from the plurality of path calculation apparatuses a plurality of forwarding paths recalculated according to the instruction; and
generating based on one of the plurality of received recalculated forwarding paths a processing rule for forwarding the packet received by the node.
Each disclosure of the above-listed Patent Literature and Non Patent Literatures is incorporated herein by reference. Modification and adjustment of each exemplary embodiment and each example are possible within the scope of the overall disclosure (including the claims) of the present invention and based on the basic technical concept of the present invention. Various combinations and selections of various disclosed elements (including each element in each claim, each element in each exemplary embodiment and each example, each element in each drawing, and the like) are possible within the scope of the claims of the present invention. That is, the present invention naturally includes various variations and modifications that could be made by those skilled in the art according to the overall disclosure including the claims and the technical concept. With respect to a numerical value range described herein, an arbitrary numerical value and a small range included in the numerical value range should be construed to be specifically described even unless otherwise explicitly described.

### REFERENCE SIGNS LIST

10, 10-1 to 10-5 packet processing apparatus
11 communication unit
12 table management unit
13 table database (table DB)
14 forwarding processing unit
20 control apparatus
21 action calculation unit
22 policy database (policy DB)
23 path determination unit
24 topology management unit
25 topology transmitting unit
26 packet processing apparatus management unit
27 processing rule database (processing rule DB)
28 processing rule management unit
29 control message processing unit
30 communication terminal
40 server (Server)
50, 50-1 to 50-3 path calculation apparatus
51 path calculation unit
52 topology management unit
53 path database (path DB)
54 flow management unit
55 control apparatus communication unit
201 node communication unit
202 path calculation apparatus communication unit
231 collision determination unit
232 path database (path DB)

What is claimed is:

1. A communication system, comprising:
a node that requests a processing rule for processing a packet;
a control apparatus that notifies a processing rule to the node in response to the request; and
a plurality of path calculation apparatuses that calculate a forwarding path of the packet received by the node, wherein
the plurality of path calculation apparatuses calculate the forwarding path based on at least one policy for calculating the forwarding path, and notifies the calculated forwarding path to the control apparatus, and
the control apparatus generates based on one of a plurality of the notified forwarding paths the processing rule for forwarding the packet received by the node.

2. The communication system according to claim 1, wherein
the plurality of path calculation apparatuses each calculate the forwarding path of the packet received by the node in response to a request from the control apparatus for the forwarding path of the packet.

3. The communication system according to claim 1, wherein
the plurality of path calculation apparatuses recalculate a forwarding path of the packet received by the node in response to a change in a connection state of a plurality of nodes managed by the control apparatus.

4. The communication system according to claim 1, wherein
the control apparatus determines the forwarding path for forwarding the packet received by the node from among the plurality of notified forwarding paths based on a predetermined condition.

5. The communication system according to claim 4, wherein
the control apparatus determines the forwarding path for forwarding the received packet by prioritizing forwarding paths that are duplicate in the plurality of notified forwarding paths.

6. The communication system according to claim 4, wherein
the control apparatus determines the forwarding path for forwarding the packet received by the node from among a plurality of the calculated forwarding paths by prioritizing a forwarding path other than a forwarding path that has been determined as a forwarding path of another packet.

7. A control apparatus, comprising:
a first unit that generates a processing rule for processing a packet received by a node, in response to a request from the node; and
a second unit that receives a plurality of forwarding paths of the packet from a plurality of path calculation apparatuses that calculate at least one of the forwarding paths of the packet received by the node based on at least one policy for calculating the at least one forwarding path, wherein
the first unit generates based on one of the plurality of forwarding paths received by the second unit the processing rule for forwarding the packet received by the node.

8. The control apparatus according to claim 7, comprising:
a third unit for determining the forwarding path for forwarding the packet received by the node from among the plurality of forwarding paths received by the second unit based on a predetermined condition.

9. The control apparatus according to claim 8, wherein
a the third unit determines the forwarding path for forwarding the packet received by the node by prioritizing forwarding paths that are duplicate in the plurality of received forwarding paths.

10. The control apparatus according to claim 8, wherein
the third unit determines the forwarding path for forwarding the packet received by the node from among the plurality of forwarding paths received by the second means by prioritizing a forwarding path other than a forwarding path that has been determined as a forwarding path of another packet.

11. The control apparatus according to claim 7, comprising:
a fourth unit that instructs the plurality of path calculation apparatuses to recalculate a forwarding path of the packet received by the node in response to a change in a connection state of a managed node(s), wherein
the second unit receives from the plurality of path calculation apparatuses a plurality of forwarding paths recalculated according to the instruction by the fourth unit; and
the first unit generates based on one of the plurality of recalculated forwarding paths received by the second unit a processing rule for forwarding the packet received by the node.

12. A communication control method, comprising:
by a control apparatus, generating a processing rule for processing a packet received by a node, in response to a request from the node; and
receiving a plurality of forwarding paths of the packet from a plurality of path calculation apparatuses that calculate at least one of the plurality of forwarding paths of the packet received by the node based on at least one policy for calculating the at least one forwarding path, wherein
the control apparatus generates based on one of the plurality of received forwarding paths the processing rule for forwarding the packet received by the node.

13. The communication control method according to claim 12, comprising:
determining the forwarding path for forwarding the packet received by the node from among the plurality of received forwarding paths based on a predetermined condition.

14. The communication control method according to claim 13, comprising:
determining the forwarding path for forwarding the packet received by the node by prioritizing forwarding paths that are duplicate in the plurality of received forwarding paths.

15. The communication control method according to claim 13, comprising:
determining the forwarding path for forwarding the packet received by the node from among the plurality of received forwarding paths by prioritizing a forwarding path other than a forwarding path that has been determined as a forwarding path of another packet.

16. The communication control method according to claim 12, comprising:
instructing the plurality of path calculation apparatuses to recalculate a forwarding path of the packet received by the node in response to a change in a connection state of a managed node(s);
receiving from the plurality of path calculation apparatuses a plurality of forwarding paths recalculated according to the instruction; and
generating based on one of the plurality of received recalculated forwarding paths a processing rule for forwarding the packet received by the node.

17. A non-transitory computer-readable recording medium storing a program that causes a control apparatus configured to control a node that processes a packet to execute:
generating a processing rule for processing the packet received by the node;
receiving a plurality of forwarding paths of the packet from a plurality of path calculation apparatuses that calculate at least one of the plurality of forwarding paths of the packet received by the node based on at least one policy for calculating the at least one forwarding path; and
generating based on one of the plurality of received forwarding paths the processing rule for forwarding the packet received by the node.

18. The non-transitory computer-readable recording medium program according to claim 17, causing the control apparatus to execute:
determining the forwarding path for forwarding the packet received by the node from among the plurality of received forwarding paths based on a predetermined condition.

19. The non-transitory computer-readable recording medium according to claim 18, wherein the program causes the control apparatus to execute:
determining the forwarding path for forwarding the packet received by the node by prioritizing forwarding paths that are duplicate in the plurality of received forwarding paths.

20. The non-transitory computer-readable recording medium according to claim 18, wherein the program causes the control apparatus to execute:
determining the forwarding path for forwarding the packet received by the node from among the plurality of received forwarding paths by prioritizing a forwarding path other than a forwarding path that has been determined as a forwarding path of another packet.

21. The non-transitory computer-readable recording medium according to claim 17, wherein the program causes the control apparatus to execute:
instructing the plurality of path calculation apparatuses to recalculate a forwarding path of the packet received by the node in response to a change in a connection state of a managed node(s);
receiving from the plurality of path calculation apparatuses a plurality of forwarding paths recalculated according to the instruction; and
generating based on one of the plurality of received recalculated forwarding paths a processing rule for forwarding the packet received by the node.

22. A communication system, comprising:
a node that requests a processing rule for processing a received packet;
a control apparatus that notifies the processing rule to the node in response to the request; and
a path calculation apparatus that calculates a plurality of forwarding paths of the packet received by the node, wherein
the path calculation apparatus calculates the plurality of forwarding paths based on a plurality of policies for calculating the plurality of forwarding paths, and notifies the plurality of forwarding paths to the control apparatus, and
the control apparatus generates the processing rule based on one of the plurality of notified forwarding paths.

23. A control apparatus comprising:
a first unit that generates a processing rule for processing a packet received by a node, in response to a request from the node; and
a second unit that receives a plurality of forwarding paths from a path calculation apparatus that calculates the plurality of forwarding paths of the packet based on a plurality of policies for calculating the plurality of forwarding paths; wherein
the first unit generates the processing rule based on one of the plurality of forwarding paths received by the second unit.
